(19) United States
(12) Patent Application Publication
(10) Pub. No.: US 2019/0259011 A1
(43) Pub. Date: Aug. 22, 2019

(54) SYSTEMS AND METHODS FOR ROUTING A CHECK TRANSACTION OVER A DEBIT CARD NETWORK

(71) Applicant: MASTERCARD INTERNATIONAL INCORPORATED, Purchase, NY (US)

(72) Inventor: Alan P. Roman, Wildwood, MO (US)

(21) Appl. No.: 16/402,895

(22) Filed: May 3, 2019

Related U.S. Application Data
(63) Continuation of application No. 11/965,494, filed on Dec. 27, 2007, now abandoned.

(51) Int. Cl. G06Q 20/20; G06Q 40/00; G06Q 20/04; G06Q 30/06

(52) U.S. Cl. CPC G06Q 20/20; G06Q 30/06; G06Q 20/042; G06Q 40/00

(57) ABSTRACT

Systems and methods for real-time check authorization and clearing are provided. In one aspect, a method is provided for processing a payment transaction using a check and an input device at a point of sale (POS). The method includes electronically capturing at the input device information from the check used in the payment transaction. The method also includes converting the check transaction to a debit transaction, transmitting data associated with the debit transaction to a transaction processor, and processing the debit transaction data to generate one of an authorization for the debit transaction and a denial for the debit transaction.

### BACKGROUND OF THE INVENTION

This invention relates generally to systems and methods for processing a payment transaction and, more particularly, to a system and method for electronically processing a payment transaction at a point of sale that includes converting a check payment into a debit card payment.

The use of paper checks continues to be the dominant method for conducting consumer transactions. Traditionally, a customer writes a check and presents it to a merchant as a method of payment for goods or services. The merchant then deposits the check with an acquiring bank. After the acquiring bank posts the check to the merchant's account, the acquiring bank sends the check to an automated clearing house (ACH). The ACH sorts all received checks according to an issuing bank, electronically transmits information relating to the checks and the checking transactions to a Federal Reserve Bank, and sends the paper checks to the associated issuing bank. The Federal Reserve Bank receives the electronically transmitted information from the ACH and, in turn, electronically transmits the information to the issuing bank associated with each check. The issuing bank then debits the customer's account held at the issuing bank. This method is time consuming and involves steps in which the check may be lost or stolen. In addition, processing paper checks is labor intensive and therefore entails significant costs to both the acquiring bank and the issuing bank. These costs are passed on to the customer, for example, in the form of fees for returning processed checks and/or through the cost of the checks themselves.

Attempts have been made to improve the efficiency of check processing. At least one such check transaction system gathers data from a check and temporarily stores the data for a future batch data transmission to either an automatic clearing house or to an issuing bank. However, this system does not automatically authorize or deny withdrawal of the transaction amount from the customer's account.

An additional example of a check transaction system is implemented in the presentment stage, wherein the acquiring bank sends the check to the issuing bank for identification and withdrawal of funds from the customer's account. The system electronically obtains data from the check and stores the information in a database. A processor obtains check data from the database and transmits the information to the issuing bank when the issuing bank is identified in the check data as the issuer endpoint in the check transaction. The processor then generates an electronic cash letter that includes the check data and a summary balance of the customer's account, and transmits the electronic cash letter to the issuing bank rather than presenting the actual paper check.

At least one other processing system includes a computerized payment system that receives checking account information and a check amount from an input device, and stores the account information and check amount in a database. The account information and check amount are then forwarded from the database to the issuing bank. Upon receiving the account information and check amount, the issuing bank posts the check as normal.

None of these known check transaction processing systems are capable of authorizing or denying a check at the time of the transaction. Accordingly, a system and method for electronically processing check transactions is needed, wherein the transaction amount is authorized and withdrawn at the time of the transaction or is denied at the time of the transaction.

### BRIEF DESCRIPTION OF THE INVENTION

In one aspect, a method is provided for processing a payment transaction using a check and an input device at a point of sale (POS). The method includes electronically capturing at the input device information from the check used in the payment transaction. The method also includes converting the check transaction to a debit transaction, transmitting data associated with the debit transaction to a transaction processor, and processing the debit transaction data to generate one of an authorization for the debit transaction and a denial for the debit transaction.

In another aspect, a method is provided for authorizing a payment transaction in real-time using a check and an input device at a merchant point of sale (POS). The method includes scanning the check at the input device, capturing customer account information from the scanned check at the input device, and converting the check transaction to a debit card transaction, wherein a predetermined debit card number is assigned to the check transaction. The method also includes transmitting a debit authorization request for the converted debit card transaction to an issuing bank, wherein the debit authorization request includes at least one of the assigned debit card number and a customer checking account number associated with the scanned check. The method also includes authorizing the payment transaction.

In another aspect, a system for processing a payment transaction using a check is provided. The system includes at least one input device located at a point of sale (POS), a database for storing information, and a server system configured to be coupled to the at least one input device and the database. The input device is configured to scan the check used in the payment transaction, capture information related to the check transaction and a customer checking account related to the check, convert the check transaction into a debit transaction by creating a debit card authorization request that includes the information captured from the scanned check, and receive one of a payment transaction authorization and a payment transaction denial from said server system.

In a further aspect, a point of sale (POS) input device is provided for use with a system for real-time authorization of a check used in a payment transaction. The input device is configured to electronically capture information from the check used in the payment transaction, convert the check transaction to a debit transaction, and generate a debit card authorization request.

In another aspect, a computer program embodied on a computer readable medium is provided for processing a payment transaction using a check and an input device at a point of sale (POS). The program includes at least one code segment that electronically captures at the input device information from the check used in the payment transaction, and converts the check transaction to a debit transaction. The code segment also transmits data associated with the debit transaction to a transaction processor and processes the debit transaction data to generate one of an authorization for the debit transaction and a denial for the debit transaction.

### BRIEF DESCRIPTION OF THE DRAWINGS

FIG. 1 is a simplified block diagram of a conventional check transaction process.

FIG. 2 is a schematic of a check that may be used in a financial transaction.

FIG. 3 is a simplified block diagram of an exemplary embodiment of a server architecture of a system in accordance with one embodiment of the present invention.

FIG. 4 is an expanded block diagram of an exemplary embodiment of a server architecture of a system in accordance with one embodiment of the present invention.

FIG. 5 is a simplified flowchart illustrating an exemplary process utilized by the system shown in FIG. 4 for processing a check transaction.

### DETAILED DESCRIPTION OF THE INVENTION

As used herein, an acquiring bank is typically a bank at which a merchant holds an account. In addition, an issuing bank is typically a bank at which a customer holds an account, which may be debited through the use of a paper check transaction and/or a debit transaction. In at least some cases, the acquiring bank and the issuing bank may be the same entity.

As used herein, a processor may include any programmable system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term “processor.”

Described in detail herein are exemplary embodiments of systems and methods that facilitate authorizing a check transaction in real time. A check transaction as referred to herein includes a payment transaction wherein the purchaser of a product or service makes the purchase using a check drawn on an account as payment. The systems and methods facilitate, for example, transferring transaction-related data electronically over a network and authorizing or denying the check transaction based on a conversion of the check transaction to a debit card transaction. A technical effect of the systems and methods described herein include at least one of (a) electronically capturing information from a check used in a transaction at a point of sale (POS) device by performing an image scan on the check or otherwise interrogating the check to capture information included within the check, wherein the captured information includes at least an amount of the check, an account number of the account associated with the check, and a routing number for an issuing bank at which the account is held by the purchaser; (b) converting the check transaction into a debit card transaction by assigning a debit card number to the transaction and generating a debit authorization request for the transaction; (c) transmitting the debit authorization message to a processing system for the issuing bank; (d) comparing the amount of the check to a current balance of the bank account associated with the check, wherein the check amount and the bank account number are extracted from the debit authorization request; and (e) and one of authorizing and denying the transaction based on the comparison such that the merchant is informed of the authorization or denial at the time of purchase.

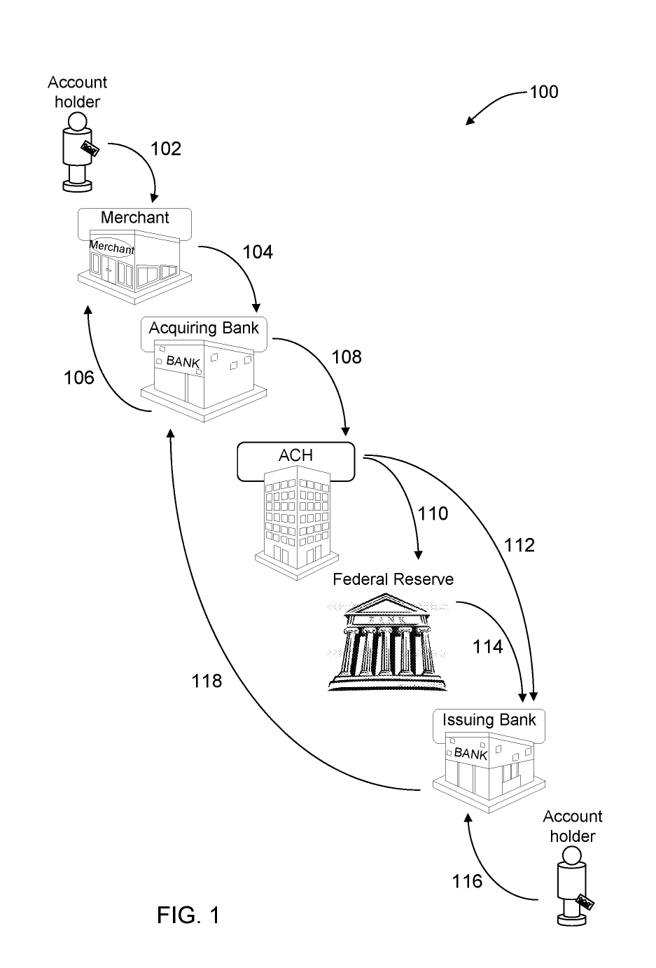

FIG. 1 is a flowchart 100 illustrating a known process for processing a check transaction. A check, as used in such a payment transaction, is a form of a bill of exchange. A check is typically a written order from one person (the payor) to another (the payee), signed by the payor, and requiring the bank at which the payor holds a checking account to pay on demand or at some fixed future date, a certain sum of money, to either the person identified as payee or to any person presenting the check, such as the bank at which the payee holds an account. Flowchart 100 shows a customer paying 102 a bill of sale at a merchant using a check. In such a case, the customer is considered the payor and the merchant is the payee. Generally, the customer also provides the merchant with identification and/or contact information in case a check is returned as nonpayable. The merchant then deposits 104 the check to an acquiring bank, which is a bank at which the merchant holds an account. Typically, at the end of the business day, the merchant deposits 104 the check, along with all other checks received that day. After the acquiring bank posts 106 the value of the check to the merchant's account, the acquiring bank sends 108 the check to an automated clearing house (ACH). One example of an automated clearing house is the National Automated Clearing House Association (NACHA). The ACH sorts all received checks according to an issuing bank, which is a bank at which the customer holds an account. The ACH also scans each check to generate an electronic image and electronically transmits 110 the electronic images to a Federal Reserve Bank. The ACH also sends 112 the paper checks to the issuing bank associated with the account on which the check was drawn. The Federal Reserve Bank receives the electronically transmitted check images from the ACH and, in turn, electronically transmits 114 the images to the issuing bank associated with each check. The issuing bank then debits 116 the customer's account held at the issuing bank and transfers 118 the check amount to the acquiring bank.

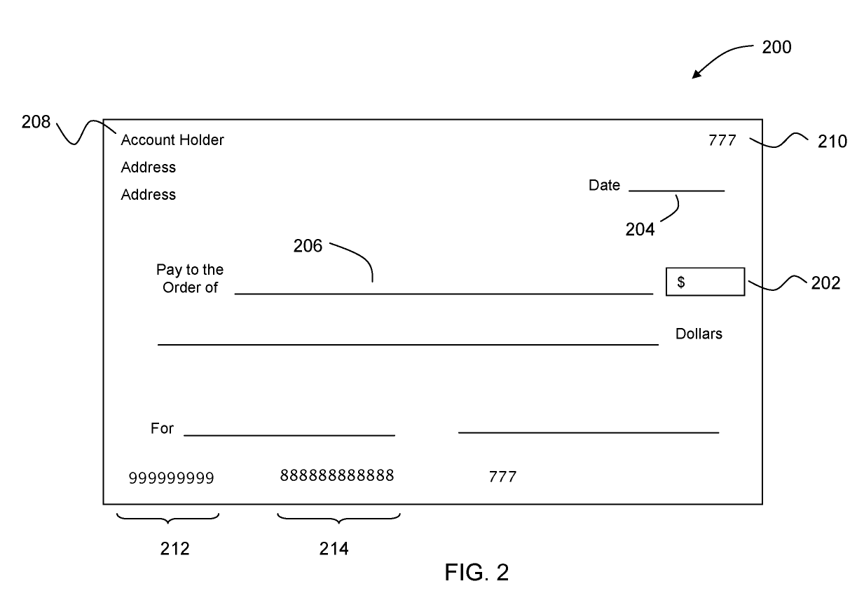

FIG. 2 is a schematic of a check 200 that may be used in a financial transaction, such as the transaction described in FIG. 1. Check 200 includes data relating to the transaction and data relating to the account on which check 200 is drawn. Transaction-related data includes, for example, a transaction amount 202, a transaction date 204, and a payee 206. Account-related data includes, for example, an account holder's name 208, a check number 210, an issuing bank routing number 212, and an account number 214. Routing number 212 and account number 214 are applied to check 200 using magnetic ink such that a Magnetic Ink Character Recognition (MICR) reader is enabled to read numbers 212 and 214 during the process described above and shown in FIG. 1.

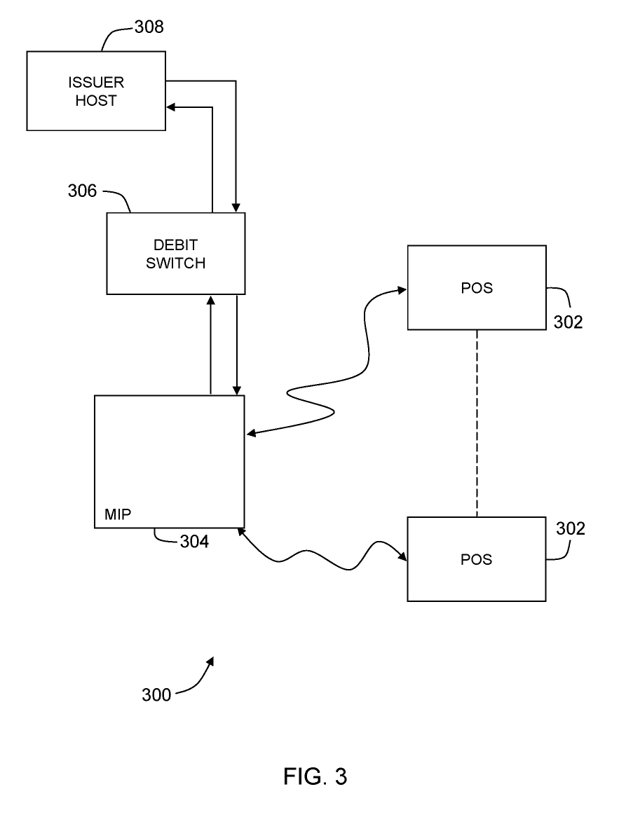

FIG. 3 is a simplified block diagram of an exemplary embodiment of a server architecture of a system 300 in accordance with one embodiment of the present invention. System 300 includes one or more point of sale (POS) systems 302. In the exemplary embodiment, system 300 also includes one or more Member Interface Processors (MIP) 304. Moreover, system 300 includes a debit switch 306, such as a MasterCard® Debit Switch server (MasterCard is a registered trademark of Master Card International Incorporated located in Purchase, N.Y.). In the exemplary embodiment, system 300 also includes one or more issuer host systems 308. POS 302, MIP 304, debit switch 306, and issuer host system 308 are interconnected to a network, such as a local area network (LAN) or a wide area network (WAN), using many interfaces including dial-in connections, cable modems, wireless modems, and/or special high-speed ISDN lines. POS 302 may be any device capable of interconnecting to the network and also completing a sales transaction such as, for example, a typical electronic cash register or any other input device configured to read, scan, or interrogate a check used for a payment transaction. Each of MIP 304, debit switch 306, and issuer host system 308 each may include a database of transaction-related information that may be accessed by POS 302 and/or MIP 304, debit switch 306, and issuer host system 308.

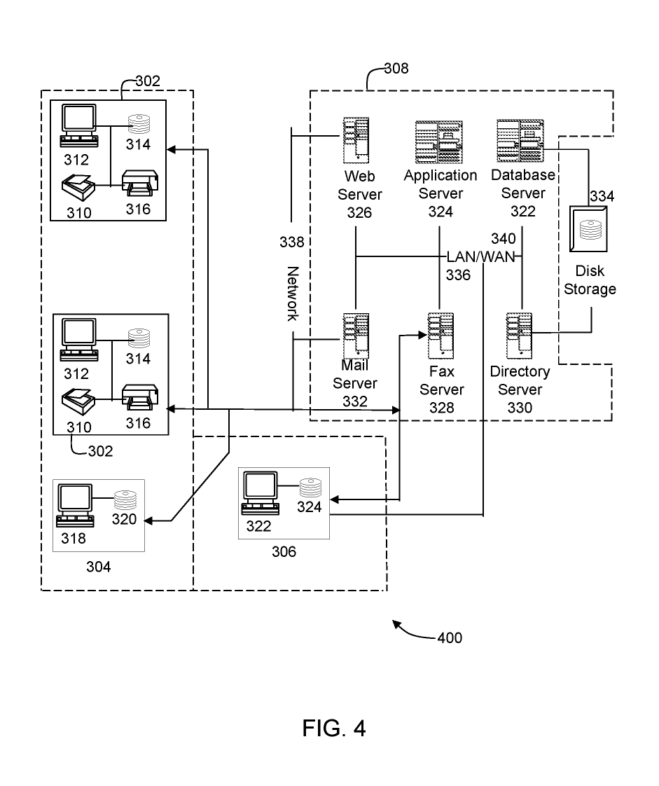

FIG. 4 is an expanded block diagram of an exemplary embodiment of a server architecture of a system 400 in accordance with one embodiment of the present invention. Components in system 400, identical to components of system 300 (shown in FIG. 3), are identified in FIG. 4 using the same reference numerals as used in FIG. 3. System 400 includes one or more POS systems 302. Each POS 302 includes a scanner 310 that scans check 200 (shown in FIG. 2) used in a transaction at POS 302, to create an electronic image of check 200. Moreover, POS 302 includes one or more processors 312 that capture information from the electronic image including, but not limited to only including, routing number 212, account number 214, and transaction amount 202 (all shown in FIG. 2). In some embodiments, POS 302 includes a printer 314, which may be used by POS 302 to, for example, print a sales slip, print validation information on check 200, and/or print a check receipt. In one embodiment, POS 302 also includes a memory that stores a lookup table (LUT) 316. LUT 316 includes a list of known issuing bank routing numbers 212 and, for each routing number 212, an associated issuing bank identification number (BIN). One such bank identifier is an Interbank Card Association (ICA) number.

In the exemplary embodiment, system 400 also includes one or more Member Interface Processors (MIP) 304 that is located at an acquiring bank at which a merchant has an account. Alternatively, MIP 304 may be located at the merchant. Each POS 302 is communicatively coupled to MIP 304 via, for example, an intranet. MIP 304 includes one or more processors 318. In an alternative embodiment, POS 302 does not include LUT 316 but, rather, MIP 304 includes LUT 316 having the list of known issuing bank routing numbers 212 and associated BINs. Moreover, system 400 also includes a debit switch 306, such as a MasterCard Debit Switch server. Debit switch 306 includes one or more processors 322. MIP 304 is further coupled, such as communicatively coupled, to debit switch 306 via, for example, an intranet.

In the exemplary embodiment, system 400 also includes one or more issuer host systems 308. Issuer host system 308 includes a database server 322, an application server 324, a web server 326, a fax server 328, a directory server 330, and/or a mail server 332. A disk storage unit 334 is coupled to database server 322 and directory server 330. Servers 322, 324, 326, 328, 330, and 332 are coupled to a local area network (LAN) 336. Issuer host system 308 is configured to be communicatively coupled to various entities such as, but not limited to, MasterCard International Incorporated, which operates debit switch 306, an acquiring bank, and/or one or more merchants using a network connection 338, such as a payment transaction processing network and/or an intranet. Although, the communication in the exemplary embodiment is illustrated as being performed using an intranet, any other wide area network (WAN) type communication network 340 may be utilized in other embodiments, i.e., the systems and methods are not limited to being practiced using the described intranet.

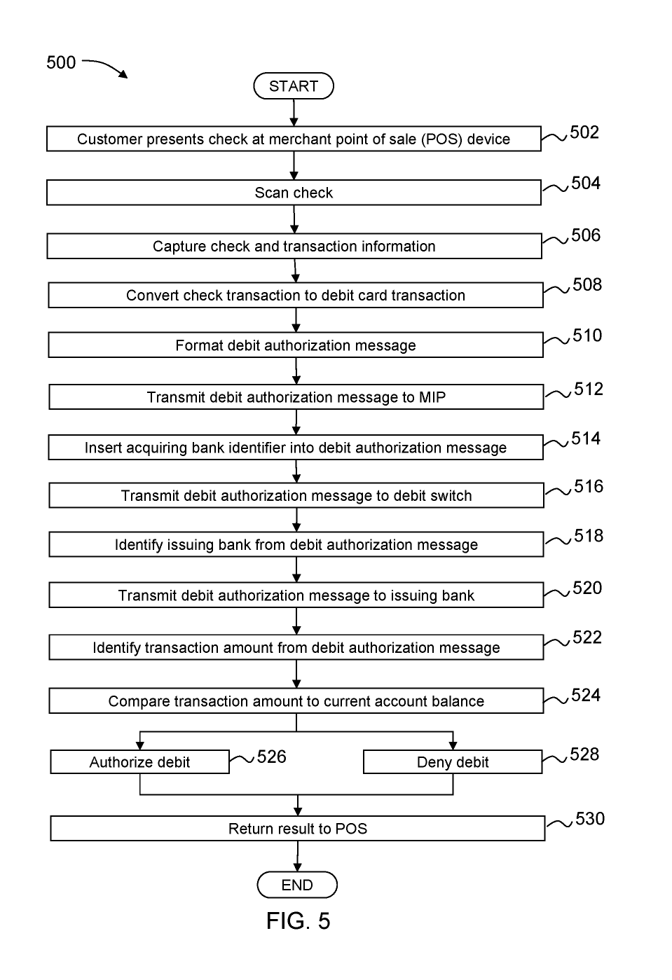

FIG. 5 is a flowchart illustrating an exemplary method 500 for processing a check transaction using system 400 (shown in FIG. 4). In the exemplary embodiment, system 400 may be utilized by an issuing bank that issues checks, a consumer who uses a check to tender payment for a purchase from a merchant, a merchant that sells a product, an acquiring bank, and a credit card network or interchange for processing a financial transaction.

In the exemplary embodiment, and referring to FIGS. 2 and 4, system 400 facilitates processing a financial transaction between a consumer and a merchant when the consumer tenders 502 payment using a check. The technical effect of the methods and systems described herein is achieved by scanning 504 the check at point of sale (POS) terminal 302 using scanner 310, thereby creating an electronic image of the check. In an alternative embodiment, scanning the check includes capturing data included within the check such that the information can be stored and processed into a debit card transaction as described below. Processor 312 analyzes the electronic image and captures 506 information relating to the transaction. For example, processor 312 captures 506 the amount 202 of the transaction, a routing number 212 of the issuing bank, and/or an account number 214 from which the transactional funds are to be withdrawn.

After capturing 506 transaction information from the electronic image, the check transaction is converted 508 to a debit card transaction for the purpose of approving or denying the transaction. POS 302, and more specifically, processor 312, searches lookup table (LUT) 316 for a bank identification number (BIN) associated with the routing number 212 captured from the electronic image. Processor 312 then generates a debit card number that includes the identified BIN. The remainder of the debit card number may be generated based in part on a known list of unused card numbers. Alternatively, the remainder of the debit card number may be generated based in part on a generic card number.

In the exemplary embodiment, the conversion of the check transaction to a debit card transaction also includes the generation and formatting 510 of a debit authorization message or debit authorization request. The format of a debit authorization request is dictated by the International Organization for Standardization. Specifically, the format is dictated by ISO 8583 entitled “Standard for Financial Transaction Card Originated Messages.” The captured transaction information, i.e., the transaction amount 202, issuing bank routing number 212, and customer account number 214, and the generated debit card number are entered into an ISO 8583 formatted message. Specifically, the transaction amount 202 is input into data element (DE) 2, the issuing bank routing number 212 is input into DE 33, and the customer account number 214 is input into DE 102. In the exemplary embodiment, the debit authorization request is formatted 510 at POS 302 and is then transmitted 512 to an interface processor such as MIP 304. In an alternative embodiment, POS 302 may instead transmit the generated debit card number and the captured transaction information to MIP 304. MIP 304 then formats 510 the debit authorization request.

As described above, in the exemplary embodiment, the debit authorization request is formatted 510 at POS 302 and then transmitted 512 to MIP 304. In the alternative embodiment, MIP 304 formats 510 the debit authorization request. In either case, MIP 304 modifies the debit authorization request by inserting 514 an acquiring bank identifier into the request at DE 32. The modified debit authorization request is then transmitted 516 to debit switch 306. Debit switch 306 receives the debit authorization request and identifies 518 the issuing bank. Specifically, debit switch 306 identifies 518 the issuing bank by parsing the debit authorization request and extracting the issuing bank routing number 212 from DE 33. Debit switch 306 then matches issuer host system 308 with the extracted issuing bank routing number 212 and transmits 520 the debit authorization request to the identified issuer host system 308.

Issuer host system 308, upon receiving the debit authorization request, identifies 522 transaction amount 202 and the customer account number 214. Specifically, issuer host system 308 parses the debit authorization request and extracts transaction amount 202 from DE 2 and extracts customer account number 214 from DE 102. Issuer host system 308 then compares 524 transaction amount 202 with a current balance of an account associated with account number 214. If there are sufficient funds available in the account to cover transaction amount 202, issuer host system 308 authorizes 526 the debit. Otherwise, if there are insufficient funds in the account, issuer host system 308 denies 528 the debit. The authorization or denial is returned 530 to POS 302 via debit switch 306 and MIP 304. If POS 302 receives an authorization for the amount of the transaction, the transaction is completed. For example, printer 314 prints a transaction receipt and/or prints a record of the transaction on the check, which is returned to the customer. If POS 302 receives a denial for the transaction, the customer may be asked to offer an alternative method of payment.

In an alternative embodiment, system 400 satisfies requirements codified by the Check Clearing for the 21^{st} Century Act (Check 21), 12 U.S.C. § 5001. Check 21 enables banks to process check information electronically and to deliver substitute checks to banks that want to continue receiving paper checks. A substitute check is the legal equivalent of the original check and includes all the information contained on the original check. In the alternative embodiment, POS 302 transmits the electronic image of the check to MIP 304. MIP 304 then transmits the electronic image to the acquiring bank. The acquiring bank then transmits the electronic image to the issuing bank using a global file transfer (GFT) network.

The systems and methods described herein enable real time check authorization without the delays involved with depositing paper checks at an acquiring bank, transferring the paper checks to a clearinghouse, and then transferring the paper checks again to an issuing bank. The merchant is instantly aware of whether the customer has sufficient funds to cover the transaction, which reduces the need to process checks that are tendered and accepted as payment without the knowledge of the sufficiency of funds. In addition, both the issuing bank and the acquiring bank benefit from lower rates of checks with insufficient funds because a check written on an account with insufficient funds will be denied during the transaction rather than after the transaction. This lowers the cost of operations for both the issuing bank and the acquiring bank.

Although the systems and methods described herein are described in the context of real time check authorization, it is understood that the apparatus and methods are not limited to such systems and/or methods. Likewise, the system components illustrated are not limited to the specific embodiments herein, but rather, components of the system can be utilized independently and separately from other components described herein.

While the invention has been described in terms of various specific embodiments, those skilled in the art will recognize that the invention can be practiced with modification within the spirit and scope of the claims.

1-25. (canceled)

26. A method for routing a physical check payment over a debit card network, the method implemented using a computing device including at least one processor in communication with a memory device, a scanning device, and a debit switch system, said method comprising:
storing, in the memory device, a table associating each of a plurality of routing numbers with a corresponding one of a plurality of bank identification numbers (BINs), wherein each of the routing numbers identifies a respective bank within a check routing system and each of the corresponding BINs identifies the respective bank within the debit switch system;
capturing, by the at least one processor from the scanning device, an electronic scan of a physical check, wherein the physical check is presented as a payment for a transaction at a point of sale associated with the computing device;
extracting, by the at least one processor, check data from the electronic scan, wherein the check data includes a physical check routing number, a physical check account number, and a physical check payment amount;
matching, by the at least one processor, the physical check routing number to one of the plurality of routing numbers in the table;
retrieving, by the at least one processor from the table, the corresponding BIN for the matched one of the routing numbers;
generating, by the at least one processor, a debit card authorization request message compliant with an ISO standard for financial transaction card interchange messaging, wherein the ISO standard defines a primary account number field, a transaction amount field, and an additional account information field, and wherein the generated debit card authorization request message includes (i) a placeholder debit card account number in the primary account number field, the placeholder debit card account number comprising the retrieved BIN and a plurality of placeholder digits, (ii) the physical check payment amount in the transaction amount field, and (iii) the physical check account number in the additional account information field;
transmitting, by the at least one processor, the generated debit card authorization request message to the debit switch system; and
receiving, by the at least one processor in response to the authorization request message, an authorization response message compliant with the ISO standard from the debit switch system, wherein the authorization response message indicates that the payment for the transaction is authorized.

27. The method according to claim 26, wherein a point of sale computing device at the point of sale includes the at least one processor.

28. The method according to claim 26, wherein a point of sale computing device at the point of sale includes the scanning device, wherein the point of sale computing device is in networked communication with a member interface processor (MIP) computing device, and wherein the MIP computing device includes the at least one processor.

29. The method according to claim 28, wherein the MIP computing device is implemented by at least one of an acquiring bank and a merchant.

30. The method according to claim 26, wherein the ISO standard further defines a forwarding institution identifier field, and wherein the generated debit card authorization request message further includes the physical check routing number in the forwarding institution identifier field.

31. The method according to claim 26, wherein the plurality of placeholder digits are selected based on at least one of (i) an unused debit card number and (ii) a generic debit card number.

32. The method according to claim 26, wherein the electronic scan includes an image scan, and wherein the method further comprises transmitting, by the at least one processor, the image scan to a computing device of the respective bank identified by the physical check routing number.

33. A system for routing a physical check payment over a debit card network, said system comprising:
a memory device storing a table associating each of a plurality of routing numbers with a corresponding one of a plurality of bank identification numbers (BINs), wherein each of the routing numbers identifies a respective bank within a check routing system and each of the corresponding BINs identifies the respective bank within a debit switch system;
a scanning device; and
at least one processor in communication with said memory device, said scanning device, and the debit switch system, said at least one processor configured to:
capture, from the scanning device, an electronic scan of a physical check, wherein the physical check is presented as a payment for a transaction at a point of sale associated with the computing device;
extract check data from the electronic scan, wherein the check data includes a physical check routing number, a physical check account number, and a physical check payment amount;
match the physical check routing number to one of the plurality of routing numbers in the table;
retrieve, from the table, the corresponding BIN for the matched one of the routing numbers;
generate a debit card authorization request message compliant with an ISO standard for financial transaction card interchange messaging, wherein the ISO standard defines a primary account number field, a transaction amount field, and an additional account information field, and wherein the generated debit card authorization request message includes (i) a placeholder debit card account number in the primary account number field, the placeholder debit card account number comprising the retrieved BIN and a plurality of placeholder digits, (ii) the physical check payment amount in the transaction amount field, and (iii) the physical check account number in the additional account information field;
transmit the generated debit card authorization request message to the debit switch system; and
receive, in response to the authorization request message, an authorization response message compliant with the ISO standard from the debit switch system, wherein the authorization response message indicates that the payment for the transaction is authorized.

34. The system according to claim 33, further comprising a point of sale computing device comprising said at least one processor.

35. The system according to claim 33, further comprising:
a point of sale computing device at the point of sale comprising said scanning device; and
a member interface processor (MIP) computing device in networked communication with said point of sale computing device, wherein said MIP computing device comprises said at least one processor.

36. The system according to claim 35, wherein said MIP computing device is implemented by at least one of an acquiring bank and a merchant.

37. The system according to claim 33, wherein the ISO standard further defines a forwarding institution identifier field, and wherein said at least one processor is further configured to generate the debit card authorization request message including the physical check routing number in the forwarding institution identifier field.

38. The system according to claim 33, wherein said at least one processor is further configured to select the plurality of placeholder digits based on at least one of (i) an unused debit card number and (ii) a generic debit card number.

39. The system according to claim 33, wherein the electronic scan includes an image scan, and wherein said at least one processor is further configured to transmit the image scan to a computing device of the respective bank identified by the physical check routing number.

40. At least one non-transitory computer readable medium comprising instructions for routing a physical check payment over a debit card network, wherein when executed by at least one processor being in communication with a memory device, a scanning device, and a debit switch system, the instructions cause the at least one processor to:
store, in the memory device, a table associating each of a plurality of routing numbers with a corresponding one of a plurality of bank identification numbers (BINs), wherein each of the routing numbers identifies a respective bank within a check routing system and each of the corresponding BINs identifies the respective bank within the debit switch system;
capture, from the scanning device, an electronic scan of a physical check, wherein the physical check is presented as a payment for a transaction at a point of sale associated with the computing device;
extract check data from the electronic scan, wherein the check data includes a physical check routing number, a physical check account number, and a physical check payment amount;
match the physical check routing number to one of the plurality of routing numbers in the table;
retrieve, from the table, the corresponding BIN for the matched one of the routing numbers;
generate a debit card authorization request message compliant with an ISO standard for financial transaction card interchange messaging, wherein the ISO standard defines a primary account number field, a transaction amount field, and an additional account information field, and wherein the generated debit card authorization request message includes (i) a placeholder debit card account number in the primary account number field, the placeholder debit card account number comprising the retrieved BIN and a plurality of placeholder digits, (ii) the physical check payment amount in the transaction amount field, and (iii) the physical check account number in the additional account information field;
transmit the generated debit card authorization request message to the debit switch system; and
receive, in response to the authorization request message, an authorization response message compliant with the ISO standard from the debit switch system, wherein the authorization response message indicates that the payment for the transaction is authorized.

41. The at least one non-transitory computer readable medium according to claim 40, wherein when executed by the at least one processor, the instructions further cause the at least one processor to process a sale of goods or services in connection with the transaction at the point of sale.

42. The at least one non-transitory computer readable medium according to claim 40, wherein when executed by the at least one processor, the instructions further cause the at least one processor to:
receive the captured electronic scan from the scanning device via a point of sale computing device at the point of sale; and
forward the authorization response message to the point of sale computing device.

43. The at least one non-transitory computer readable medium according to claim 40, wherein the ISO standard further defines a forwarding institution identifier field, and wherein when executed by the at least one processor, the instructions further cause the at least one processor to generate the debit card authorization request message including the physical check routing number in the forwarding institution identifier field.

44. The at least one non-transitory computer readable medium according to claim 40, wherein when executed by the at least one processor, the instructions further cause the at least one processor to select the plurality of placeholder digits based on at least one of (i) an unused debit card number and (ii) a generic debit card number.

45. The at least one non-transitory computer readable medium according to claim 40, wherein the electronic scan includes an image scan, and wherein when executed by the at least one processor, the instructions further cause the at least one processor to transmit the image scan to a computing device of the respective bank identified by the physical check routing number.
